(19) United States
(12) Patent Application Publication
(10) Pub. No.: US 2026/0012055 A1
(43) Pub. Date: Jan. 8, 2026

(54) ELECTRIC MOTOR

(71) Applicant: MITSUBA Corporation, Gunma (JP)

(72) Inventors: Tomohiko Annaka, Gunma (JP); YUSAKU ARAI, Gunma (JP); TOSHINORI HOSHINO, Gunma (JP)

(73) Assignee: MITSUBA Corporation, Gunma (JP)

(21) Appl. No.: 18/843,299

(22) PCT Filed: Feb. 15, 2024
(86) PCT No.: PCT/JP2024/005242

§ 371 Date: Sep. 2, 2024

(30) Foreign Application Priority Data
Jul. 18, 2023 (JP) 2023-116450

(51) Int. Cl. H02K 3/52; B62M 7/06; H02K 21/16

(52) U.S. Cl. CPC H02K 3/522; H02K 21/16; B62M 7/06; H02K 2203/09

(57) ABSTRACT

An electric motor includes a stator and a rotor. A plurality of coils of the stator are wound around teeth of a stator core. A busbar unit is provided on one end side in the axial direction of the stator core. The busbar unit has a plurality of busbar terminals configured to straddle winding portions of adjacent coils in a circumferential direction. Each of the busbar terminals is provided with a start line connection portion to which a start line portion of one adjacent coil is connected and an end line connection portion to which an end line portion of other coil is connected. A filling opening for filling an adhesive into a winding portion of the coil in a vicinity of the end line portion is provided between the start line connection portion and the end line connection portion of each of the busbar terminals.

### TECHNICAL FIELD

The present invention relates to an electric motor used as a drive source for a vehicle, etc.

### RELATED ART

A known electric motor used as a drive source for a vehicle and the like includes an annular stator and a rotor provided on an inner side in a radial direction of the stator, with a plurality of coils wound around the stator to generate a rotating magnetic field (see, for example, Patent Document 1).

The electric motor described in Patent Document 1 includes an annular stator fixed in a housing and a rotor rotatably provided on an inner side in a radial direction of the stator. The stator includes a stator core made of a magnetic material, an insulator mounted to the stator core, a plurality of coils wound around the stator core via the insulator, and a busbar unit for supplying a drive current to each coil. The rotor has a rotor core made of a magnetic material provided with a plurality of permanent magnets. Further, the busbar unit is provided on one end side in the axial direction of the stator core.

The stator core of the stator has a plurality of teeth protruding from a plurality of points in a circumferential direction to an inner side in a radial direction, and insulators are mounted to the plurality of teeth. Each coil is wound around a plurality of teeth via an insulator. The busbar unit has U-phase, V-phase, and W-phase busbars, and these busbars are held by an insulating resin block. Each busbar includes a substantially C-shaped busbar body and a plurality of busbar terminals protruding from the busbar body to an outer side in a radial direction. Each busbar terminal is configured to straddle winding portions of adjacent coils in a circumferential direction when viewed in the axial direction. Then, each busbar terminal is connected to a start line portion of one adjacent coil in a circumferential direction and an end line portion of other adjacent coil in a circumferential direction. Further, U-phase, V-phase, and W-phase drive currents are supplied to the busbar body of each busbar from a power terminal.

### CITATION LIST

### Patent Document

[Patent Document 1] Japanese Patent Application Laid-Open (JP-A) No. 2021-164260.

### SUMMARY

### Technical Problem

Incidentally, the coil wound around each of the teeth has a start line portion where the winding begins and an end line portion where the winding ends, the start line portion is configured on the inner side (inner layer) of the winding portion of the coil, and the end line portion is configured on the outer side (outer layer) of the winding portion of the coil. The position of the coil in the vicinity of the start line portion is constrained by the coil of the winding portion laminated on the upper layer, but the position of the coil in the vicinity of the end line portion is not constrained by the coil of the winding portion. Due to this, the vicinity of the end line portion of the coil is separately fixed to the winding portion of the coil using adhesive.

In the above-mentioned electric motor, a busbar unit is mounted to an end portion in the axial direction of a stator (insulator) around which the coil is wound, and a plurality of busbar terminals of the busbar unit are provided to cover a gap between adjacent coils from the outer side in the axial direction. Due to this, the base portion side (the side adjacent to the winding portion of the coil) of the start line portion and the end line portion of each coil is covered on the outer side in the axial direction by the busbar terminal. Thus, when the end line portion of the coil is fixed to the winding portion of the coil using an adhesive as described above, a large amount of adhesive must be poured from a position spaced from the base portion of the end line portion so that the adhesive reaches the base portion of the end line portion. This requires a larger amount of adhesive to be filled and increases the time it takes for the adhesive to harden, which increases the assembly time of the electric motor.

In view of the above, an object of the present invention is to provide an electric motor which may reduce the amount of adhesive required to fix the vicinity of the end line portion of the coil and shorten the assembly work time.

### Solution to Problem

The electric motor according to one aspect of the present invention includes: a stator, having an annular shape; a rotor, provided on an inner side in a radial direction of the stator and rotating relative to the stator. The stator includes: a stator core, having a plurality of teeth protruding from a plurality of points in a circumferential direction to an inner side in a radial direction; a plurality of coils, wound around each of the teeth; and a busbar unit, provided on one end side in an axial direction of the stator core and supplying electric power to each of the coils wound around the teeth. The busbar unit has a plurality of busbar terminals configured to straddle winding portions of adjacent coils in a circumferential direction when viewed in the axial direction. Two positions spaced apart in a circumferential direction of each of the busbar terminals are provided with a start line connection portion to which a start line portion of one adjacent coil is connected and an end line connection portion to which an end line portion of other adjacent coil in a circumferential direction is connected, respectively. A filling opening for filling an adhesive into a winding portion of the coil in a vicinity of the end line portion is provided between the start line connection portion and the end line connection portion of each of the busbar terminals.

When manufacturing the electric motor of this aspect, in the case where the end line portion of the coil wound around each of the teeth is to be connected to the end line connection portion of the busbar terminal, the following work is carried out as a preliminary process to the connection work.

That is, the adhesive is filled into the winding portion in the vicinity of the end line portion of the coil through a filling opening provided between the start line connection portion and the end line connection portion of each of the busbar terminals. When the filled adhesive hardens, the vicinity of the end line portion of the coil is fixed to the winding portion of the coil, and the end line portion of the coil does not separate from the winding portion. Due to this, the end line portion of the coil may be subsequently easily and stably connected to the end line connection portion of the corresponding busbar terminal.

In the electric motor of this aspect, when adhering the vicinity of the end line portion of the coil to the winding portion, the adhesive may be directly filled in the vicinity of the end line portion of the coil through the filling opening of the busbar terminal. This prevents the adhesive from flowing into unnecessary portions other than those near the end line portions. As a result, the amount of adhesive to be filled may be reduced, and the time it takes for the adhesive to harden may be shorten, thereby shortening the time required for assembly.

The filling opening may be configured at a position closer to a base portion of the end line portion of other adjacent coil than to a base portion of the start line portion of one adjacent coil.

In this case, since the filling opening is configured closer to the base portion of the end line portion of the other coil than to the base portion of the start line portion of the one coil, the winding portion of the coil in the vicinity of the end line portion may be easily and accurately filled through the filling opening.

The filling opening may be formed at a position closer to the end line connection portion than to the start line connection portion of the busbar terminal.

In this case, since the filling opening is formed at a position closer to the end line connection portion than to the start line connection portion of each of the busbar terminals, it is possible to position each of the busbar terminals at the intermediate position of the line winding portions of two adjacent coils in the circumferential direction, while shifting only the filling opening toward the base portion side of the start line portion of the one coil.

The busbar unit may include three busbars for U-phase, V-phase, and W-phase; and an insulating resin block, holding the three busbars in a mutually separated state, and Each of the busbars may include a busbar body, having a substantially C-shape and embedded in the resin block; and a busbar terminal, protruding from the busbar body to an outer side in a radial direction.

In this case, by positioning and fixing the busbar unit to one end side in the axial direction of the stator core, the filling openings of all busbar terminals may be positioned at positions where the adhesive 70 may be easily filled. Thus, when this configuration is adopted, the manufacture of the electric motor may be simplified.

### Effects of Invention

In the electric motor according to the present invention, the adhesive may be directly filled in the vicinity of the end line portion of the coil through the filling opening of the busbar terminal, so that the amount of adhesive required to fix the vicinity of the end line portion of the coil may be reduced and the assembly time may be shortened.

### BRIEF DESCRIPTION OF DRAWINGS

FIG. 1 is a side view of the electric motor according to the embodiment.

FIG. 2 is a plan view of the electric motor according to the embodiment with some parts removed.

FIG. 3 is a cross-sectional view taken along line III-III in FIG. 2.

FIG. 4 is a cross-sectional view taken along line IV-IV in FIG. 2.

FIG. 5 is a perspective view of the electric motor according to the embodiment with some parts removed.

FIG. 6 is a perspective view of the busbar unit according to the embodiment viewed from one side in the axial direction.

FIG. 7 is a perspective view of the busbar unit according to the embodiment viewed from other side in the axial direction.

FIG. 8 is a plan view of the stator according to the embodiment.

FIG. 9 is an enlarged view of part IX in FIG. 8.

FIG. 10 is a side view illustrating an example of the electric motorcycle equipped with the electric motor according to the embodiment.

FIG. 11 is a side view illustrating another example of the electric motorcycle equipped with the electric motor according to the embodiment.

### DESCRIPTION OF EMBODIMENTS

Hereinafter, one embodiment of the present invention is described with reference to the drawings.

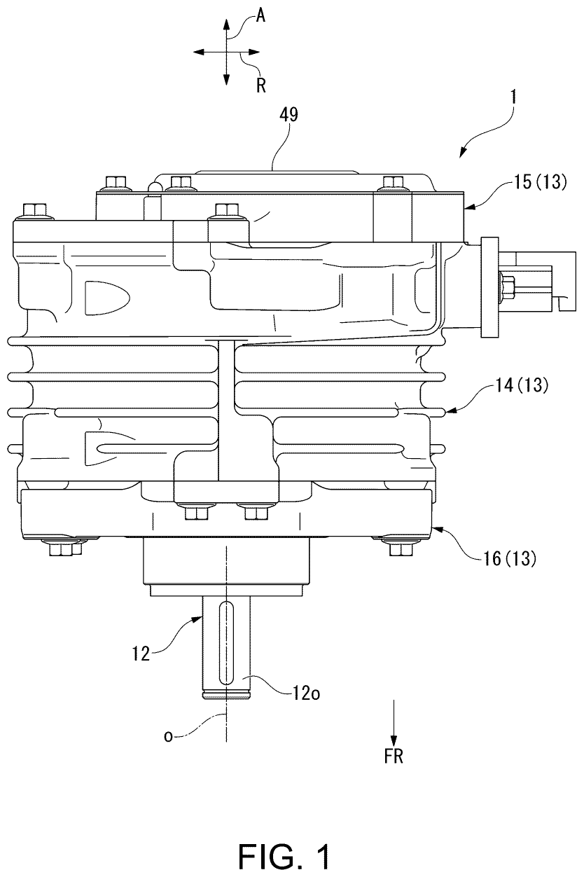

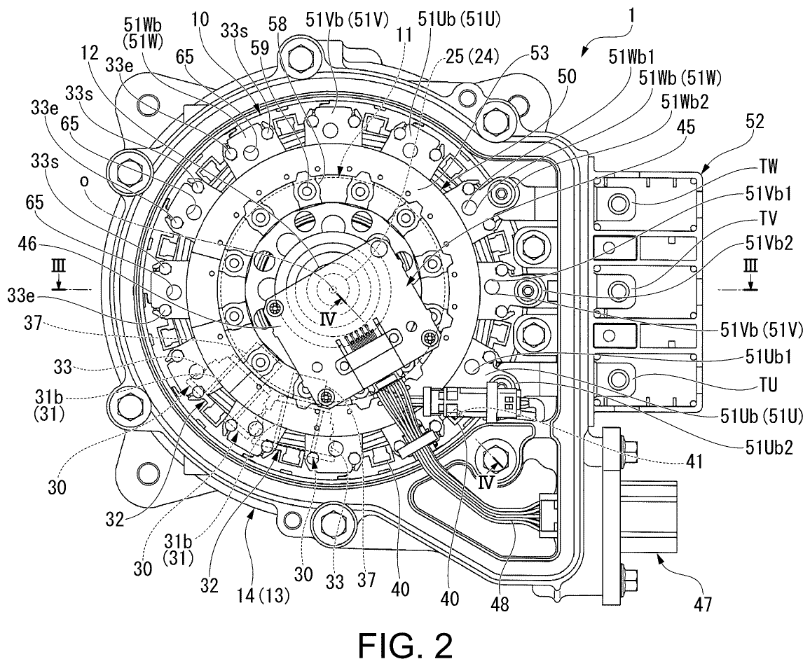

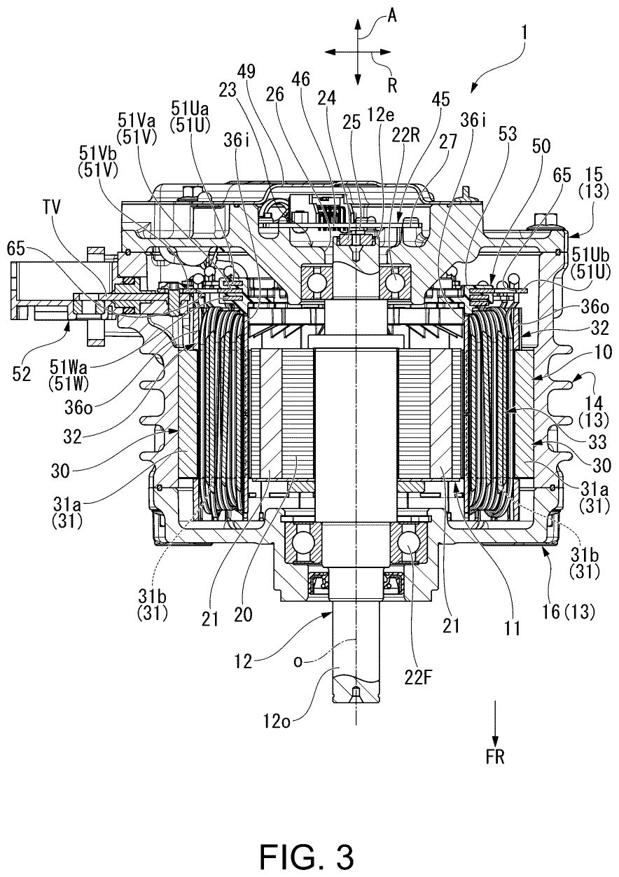

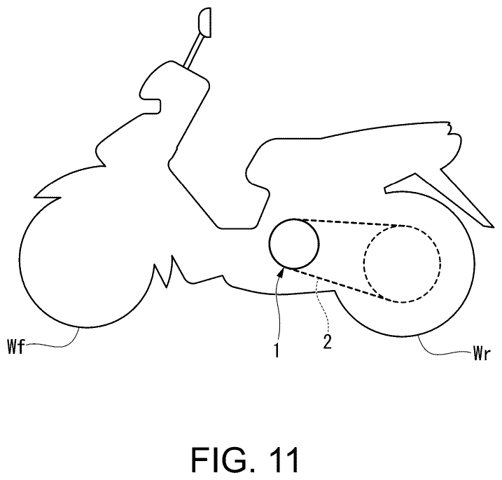

FIG. 1 is a side view of the electric motor 1 according to this embodiment, and FIG. 2 is a plan view of the electric motor 1 according to the embodiment with some parts removed. Further, FIG. 3 is a cross-sectional view of the electric motor 1 taken along line III-III in FIG. 2. The electric motor 1 of this embodiment shown in these figures is used, for example, as a drive source for an electric motorcycle. When used as a drive source for an electric motorcycle, the electric motor 1 may be provided on the side portion of the rear wheel Wr, which is a drive wheel, as shown in FIG. 10. In this case, the motive power of the electric motor 1 is transmitted to the rear wheel Wr via a gear mechanism (not shown). The configuration of the electric motor 1 is not limited thereto, and the electric motor 1 may also be mounted on the vehicle frame between the front wheel Wf and the rear wheel Wr as shown in FIG. 11. In this case, the motive power of the electric motor 1 is transmitted to the rear wheel Wr via the chain 2 and the belt.

The electric motor 1 includes a stator 10 having an annular shape and a rotor 11 rotatably provided on an inner side in a radial direction of the stator 10. A small gap (air gap) is provided between the outer circumferential surface of the rotor 11 and the stator 10. The rotor 11 has a rotary shaft 12 at the position of the axial center.

In the following, unless a direction is specifically specified, a direction along the axial center o of the rotary shaft 12 is referred to as an “axial direction”, a direction perpendicular to the axial center o is referred to as a “radial direction”, and a circumferential direction centered on the axial center o is referred to as a “circumferential direction”. At appropriate locations on the drawing, the arrow A indicates the axial direction, the arrow R indicates the radial direction, and the arrow C indicates the circumferential direction.

The stator 10 and the main portion of the rotor 11 inside the stator 10 are housed inside a housing 13. The housing 13 includes a substantially cylindrical case body 14, a rear cover 15 closing one end side of the case body 14 in the axial direction, and a front cover 16 closing the other end side of the case body 14 in the axial direction. The rear cover 15 and the front cover 16 are fixed to the case body 14 by bolts or the like.

In the following description, the side of the case body 14 on which the front cover 16 is positioned is referred to as the “front side,” and the side on which the rear cover 15 is positioned is referred to as the “rear side.” In addition, the arrow FR pointing to the front side is written in the appropriate location in the drawing.

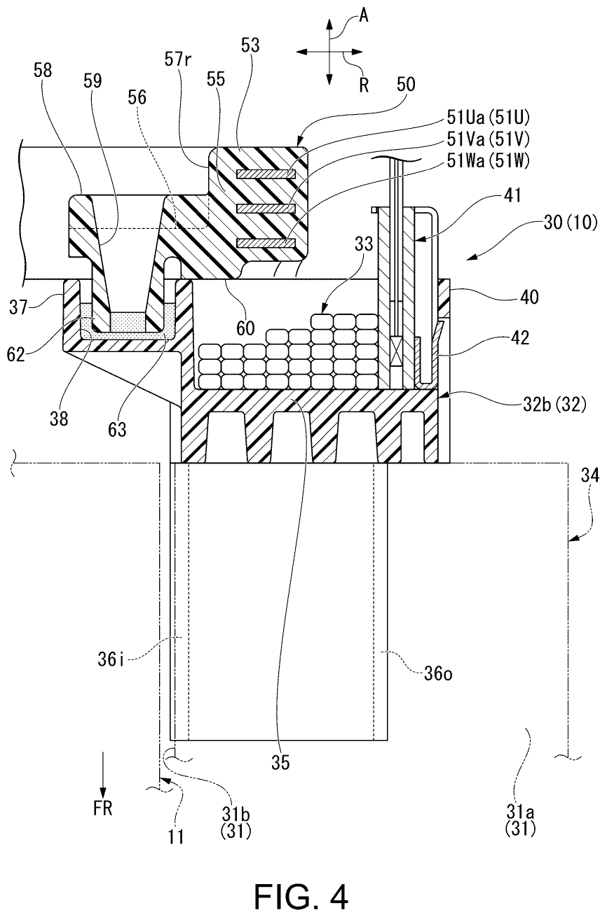

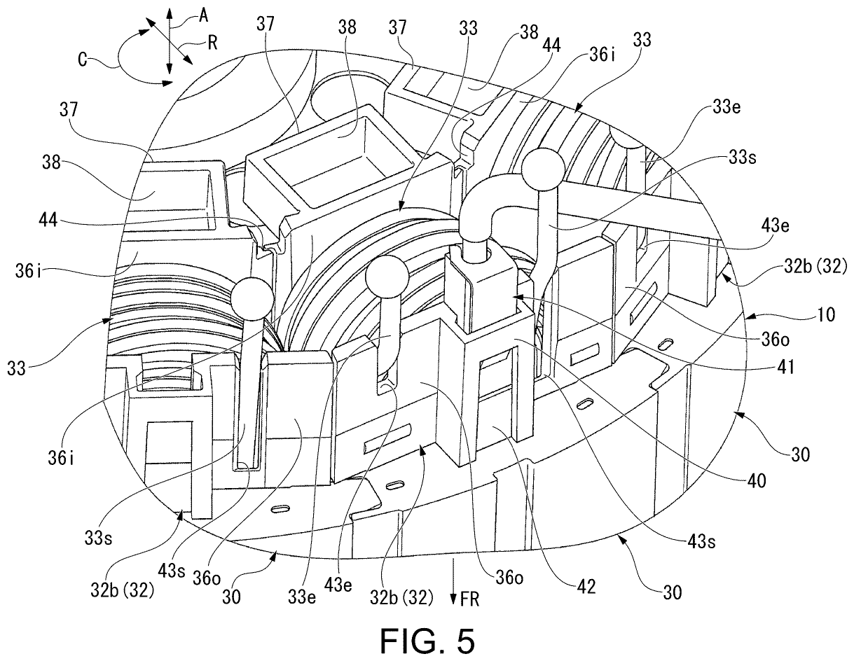

FIG. 4 is a cross-sectional view of the electric motor 1 taken along the line IV-IV in FIG. 2, and FIG. 5 is a perspective view of the electric motor 1 with some parts such as the rear cover 15 removed.

As shown in FIG. 2 to FIG. 5, the stator 10 is formed in a generally cylindrical shape by connecting a plurality of split cores 30 of the same shape in an annular shape. In this embodiment, the stator 10 is formed by connecting a total of twelve split cores 30. It is noted that in FIG. 2, only two split cores of the twelve split cores 30 are shown in detail by dotted lines. The split core 30 includes a core portion 31, an insulator 32, and a coil 33.

The core portion 31 is formed by stacking a plurality of steel plates (magnetic bodies) in a substantially T-shape when viewed in the axial direction in the axial direction. The core portion 31 includes a core back split piece 31a having an arc shape when viewed in the axial direction, and teeth 31b protruding from a substantial center position in the circumferential direction of the core back split piece 31a to the inner side in the radial direction. The above-mentioned substantially T-shape is formed by the core back split piece 31a and the teeth 31b. The core portions 31 of the plurality of split cores 30 form a stator core 34 having an annular shape by connecting two end portions of the core back split piece 31a in the circumferential direction to the end portions of the adjacent core back split piece 31a. In this state, each of the teeth 31b protrudes in the radial direction toward the axial center o.

The insulator 32 is made of an insulating resin material. The insulator 32 is mounted to the outer circumferential surface of the teeth 31b of the corresponding core portion 31. The teeth 31b protruding from the core back split piece 31a of the core portion 31 to the inner side in the radial direction are formed so that the cross-section perpendicular to the radial direction is substantially rectangular. The insulator 32 covers two surfaces along the axial direction of the substantially rectangular cross section of the teeth 31b and two surfaces on one end side and the other end side in the axial direction. In other words, the insulator 32 covers the periphery of the substantially rectangular cross section of the corresponding teeth 31b. Each insulator 32 is configured by two split blocks 32b divided in the axial direction. In FIG. 4, only the split block 32b on the rear side is shown.

As shown in FIG. 4, the insulator 32 includes an encircling portion 35 having a rectangular cylindrical shape that surrounds the outer circumferential surface of the corresponding teeth 31b, an outer side flange portion 36o that protrudes outward (outer side in the circumferential direction and the axial direction) from an end portion of the encircling portion 35 on the outer side in the radial direction (on the core back split piece 31a side), and an inner side flange portion 36i protruding outward (outer side in the circumferential direction and axial direction) from an end portion of the encircling portion 35 on the inner side in the radial direction. A corresponding coil 33 is wound around the outer circumferential surface of the encircling portion 35. Each coil 33 is wound around the outer circumferential surface of the encircling portion 35 in a state in which its position is restricted in a radial direction by the inner side flange portion 36i and the outer side flange portion 36o. Each coil 33 is wound around the outer circumference of the corresponding teeth 31b via the encircling portion 35 of the insulator 32.

It is noted that in this embodiment, each coil 33 is made of a rectangular wire having a substantially rectangular cross section.

As shown in FIG. 2, FIG. 4, and FIG. 5, a protruding piece 37 that protrudes toward the inner side in the radial direction is extended along the end portion on the rear side in the axial direction of the inner side flange portion 36i of the split block 32b on the rear side of each insulator 32. The protruding piece 37 is a block having a substantially rectangular shape when viewed in the axial direction, and on a surface facing the rear side in the axial direction, a concave portion 38 having a substantially rectangular shape when viewed in the axial direction is formed. The concave portion 38 opens towards the rear side in the axial direction.

Further, as shown in FIG. 4 and FIG. 5, a thermistor housing portion 40 that bulges outward in a rectangular shape on the outer side in the radial direction is provided at a substantially center portion in the circumferential direction of the outer side flange portion 36o of the split block 32b on the rear side of each insulator 32. The thermistor housing portion 40 is configured on the outer side in the axial direction (rear side) of the end surface on the rear side of the stator core 34 of the outer side flange portion 36o of the split block 32b on the rear side. A thermistor 41 for detecting the temperature of the coil 33 is mounted to the thermistor housing portion 40 of one insulator 32 of the plurality of insulators 32. A notched portion (not shown) is provided on the inner wall of the thermistor housing portion 40 on the inner side in the radial direction so that a temperature detection portion of the thermistor 41 housed in the thermistor housing portion 40 abuts against the outer surface of the coil 33. The sign 42 in FIG. 4 and FIG. 5 denotes a plate spring material for pressing the thermistor 41 against the outer surface of the coil 33.

As shown in FIG. 5, a pair of coil fitting grooves 43s and 43e opening toward the rear side are formed on the end edge on the rear side of the outer side flange portion 36o of each split block 32b. These coil fitting grooves 43s and 43e are provided on two sides of the circumferential direction sandwiching the thermistor housing portion 40 therebetween. Each of the coil fitting grooves 43s and 43e penetrates the outer side flange portion 36o in the thickness direction. A start line portion 33s of the coil 33 wound around the corresponding teeth 31b via the insulator 32 is fitted into the coil fitting groove 43s on one side and provisionally locked thereto. An end line portion 33e of the coil 33 wound around the corresponding teeth 31b via the insulator 32 is fitted into the coil fitting groove 43e on the other side and provisionally locked thereto. The start line portion 33s and the end line portion 33e of the coil 33 fitted into the coil fitting grooves 43s and 43e are pulled out in the radial direction of the outer side flange portion 36o. The start line portion 33s and the end line portion 33e of the coil 33 pulled out to the outer side in the radial direction of the outer side flange portion 36o are connected to busbars 51U, 51V, and 51W (described later) after the plurality of split blocks 32b are assembled in an annular shape.

The rotor 11, which is configured on the inner side in the radial direction of the stator 10, includes a rotor body 20 formed in a substantially cylindrical shape by stacking a plurality of steel plates (magnetic bodies) in the axial direction, as shown in FIG. 3. The rotary shaft 12 is press-fitted and fixed in the rotation center (axial center portion) of the rotor body 20. A plurality of substantially plate-shaped permanent magnets 21 are embedded inside the rotor body 20. The permanent magnets 21 are arranged in the circumferential direction of the rotor body 20 such that the north poles and south poles alternately face the outer side in the radial direction.

The rotor 11 of this embodiment adopted a so-called “IPM (interior permanent magnet) structure” in which a plurality of permanent magnets are embedded inside the rotor body 20, but the structure of the rotor 11 is not limited thereto. The rotor 11 may have a so-called “SPN (surface permanent magnet) structure” in which a permanent magnet 21 is mounted to the outer surface of the rotor body 20.

The rotary shaft 12 protrudes with respect to the rotor body 20 at one end side (rear side) and the other end side (front side) in the axial direction. One end side of the rotary shaft 12 in the axial direction is rotatably supported by the rear cover 15 via a bearing 22R. The other end side of the rotary shaft 12 in the axial direction penetrates the front cover 16 and is rotatably supported by the front cover 16 via a bearing 22F. One end portion of the rotary shaft 12 penetrating the front cover 16 is defined as a rotation output portion 12o to which an output gear or sprocket is mounted. The rotation output portion 12o protrudes from the housing 13 of the electric motor 1 to the outer side in the axial direction, and, as shown in FIG. 10 and FIG. 11, when mounted to the body of a motorcycle, protrudes to the outer side in the width direction of the body. A recessed shape portion 23 opening toward the rear side is formed on the surface on the rear side of the rear cover 15. One end portion of the rotary shaft 12 penetrates the rear cover 15 in the thickness direction so that an end surface 12e on the rear side is exposed within the recessed shape portion 23. A sensor magnet 24 having a substantially disk shape is fixed to an end surface 12e of the rotary shaft 12. The sensor magnet 24 serves as a detection target for detecting the rotation state when the rotation state of the rotor 11 (rotary shaft 12) is detected by a rotation sensor 25, which is described later.

As shown in FIG. 3, a plurality of support portions 27 project within the recessed shape portion 23 of the rear cover 15 so as to surround the through hole 26 of the rear cover 15. A sensor unit 45 is fixed to the tip end part of each of these support portions 27. The sensor unit 45 includes a rotation sensor 25 including a magnetic resistance element, and a sensor substrate 46 on which the rotation sensor 25 is mounted. The sensor substrate 46 is fixed to the support portion 27 so that the rotation sensor 25 faces the sensor magnet 24 on the end surface 12e of the rotary shaft 12 with a small gap therebetween.

As shown in FIG. 2, the circuit on the sensor substrate 46 is electrically connected to a sensor connector 47 installed in the housing 13 via a sensor harness 48. The terminal portion of the sensor connector 47 is connected to a controller (not shown) via a wire (not shown). It is noted that as described above, the recessed shape portion 23 of the rear cover 15 in which the sensor unit 45 is mounted is closed by the cover member 49 shown in FIG. 1 and FIG. 3.

Further, as shown in FIG. 2 to FIG. 4, a busbar unit 50 having a substantially annular shape is mounted to the end portion on the rear side of the insulator 32. The busbar unit 50 includes the busbars 51U, 51V, and 51W for supplying drive current to the coil 33 wound around each of the teeth 31b of the stator core 34. It is noted that the busbar unit 50 constitutes the stator 10 together with the stator core 34 having the teeth 31b and the coil 33 wound around each of the teeth 31b.

A drive connector 52 is mounted to the case body 14 of the housing 13. The drive connector 52 is mounted to the case body 14 by penetrating the surrounding wall near the rear side of the case body 14. As shown in FIG. 2, a U-phase power terminal TU, a V-phase power terminal TV, and a W-phase power terminal TW are configured in the drive connector 52. These power terminals TU, TV, TW penetrate the surrounding wall of the case body 14, and have end portions inside the case body 14 electrically connected to the busbars 51U, 51V, and 51W, respectively. Further, the end portions of the power terminals TU, TV, and TW outside the case body 14 are connected to a drive circuit of a controller (not shown). A drive current is supplied from a drive circuit to the coil 33 wound around each of the teeth 31b of the stator 10 via the power terminals TU, TV, and TW and the busbars 51U, 51V, and 51W.

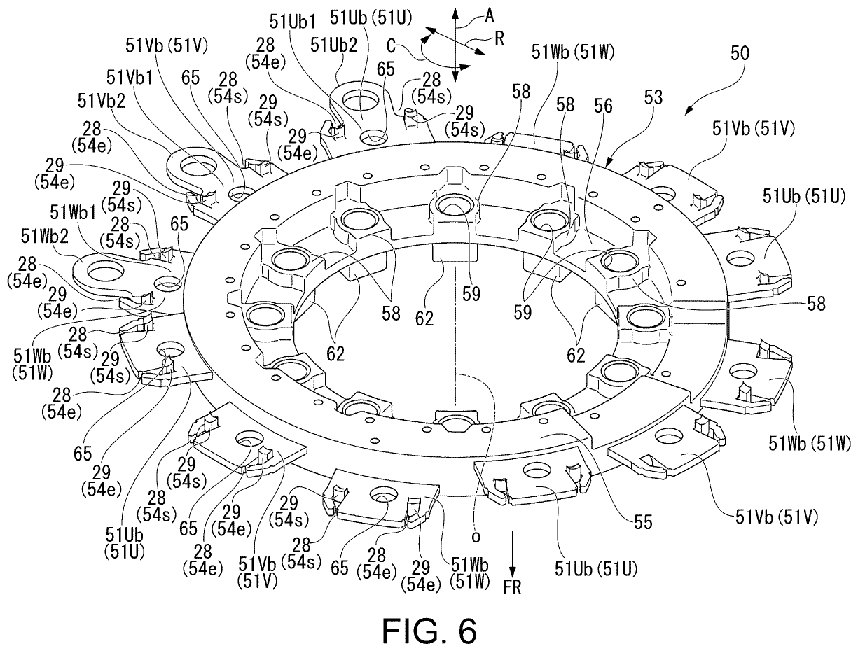

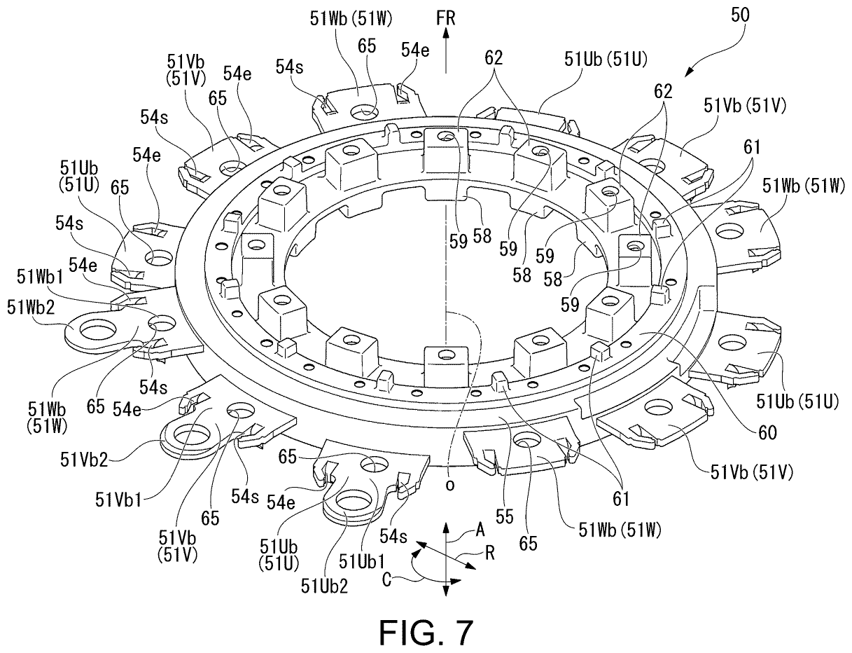

FIG. 6 is a perspective view of the busbar unit 50 viewed from the rear side, and FIG. 7 is a perspective view of the busbar unit 50 viewed from the front side.

The busbar unit 50 has busbar bodies 51Ua, 51Va, and 51Wa (see FIG. 3 and FIG. 4) of the three busbars 51U, 51V, and 51W embedded in a resin block 53 made of an insulating resin material and having an annular shape, spaced apart in the axial direction. Each of the busbar bodies 51Ua, 51Va, 51Wa is formed of a conductive metal plate having a substantially C-shape when viewed in the axial direction. The annular shaped resin block 53 is fixed to the end portion on the rear side of each of the insulators 32 of the split core 30 assembled in an annular shape. In this state, the resin block 53 is provided so as to be concentric with the stator core 34. The specific way the resin block 53 is fixed with respect to the insulator 32 is described in detail later.

Four busbar terminals 51Ub, 51Vb, and 51Wb are provided at the outer circumferential end portion of each of the substantially C-shaped busbar bodies 51Ua, 51Va, and 51Wa, respectively, protruding toward the outer side in the radial direction. Each of the four busbar terminals 51Ub, 51Vb, and 51Wb for the U-phase, V-phase, and W-phase are provided at equal intervals in the circumferential direction of the resin block 53. Each of the busbar terminals 51Ub, 51Vb, and 51Wb is formed integrally with the corresponding busbar bodies 51Ua, 51Va, and 51Wa from a conductive metal plate.

Three of the four busbar terminals 51Ub of the U-phase are formed in a substantially rectangular shape having a constant width along the circumferential direction of the resin block 53. One of the remaining four busbar terminals 51Ub of the U-phase has a shape in which a terminal base portion 51Ub1 having a substantially rectangular shape with a constant width along the circumferential direction of the resin block 53 is connected to a terminal connection portion 51Ub2, which bulges outward in a mountain shape on the outer side in the radial direction. Similarly, three of the four busbar terminals 51Vb and 51Wb of the V-phase and the W-phase are formed in a substantially rectangular shape having a constant width along the circumferential direction of the resin block 53, and one of the remaining four busbar terminals 51Vb and 51Wb of the V-phase and the W-phase have a shape in which terminal base portions 51Vb1 and 51Wb1 having a substantially rectangular shape with a constant width along the circumferential direction of the resin block 53 are connected to terminal connection portions 51Vb2 and 51Wb2, which bulge outward in a mountain shape on the outer side in the radial direction. The terminal base portions 51Ub1, 51Vb1, and 51Wb1 of the busbar terminals 51Ub, 51Vb, and 51Wb, which have the terminal connection portions 51Ub2, 51Vb2, and 51Wb2, have substantially the same shape as the other busbar terminals 51Ub, 51Vb, and 51Wb.

The V-phase busbar terminal 51Vb is provided on one side in the circumferential direction of each U-phase busbar terminal 51Ub, the W-phase busbar terminal 51Wb is provided on one side in the circumferential direction of each V-phase busbar terminal 51Vb, and the U-phase busbar terminal 51Ub is provided on one side in the circumferential direction of each W-phase busbar terminal 51Wb. The adjacently arranged U-phase busbar terminal 51Ub, V-phase busbar terminal 51Vb, and W-phase busbar terminal 51Wb are provided at equal intervals in the circumferential direction of the resin block 53. The busbar terminals 51Ub, 51Vb, and 51Wb of each phase having the terminal connection portions 51Ub2, 51Vb2, and 51Wb2 are configured in a specific region in the circumferential direction of the resin block 53. The terminal connection portions 51Ub2, 51Vb2, and 51Wb2 of these busbar terminals 51Ub, 51Vb, and 51Wb are electrically connected to the corresponding power terminals TU, TV, and TW of the drive connector 52 (see FIG. 2).

As shown in FIG. 6 and FIG. 7, each of the busbar terminals 51Ub, 51Ub, and 51Ub for the U-phase, the V-phase, and the W-phase is provided with a start line connection portion 54s and an end line connection portion 54e for respectively connecting the start line portion 33s and an the end line portion 33e (see FIG. 5) of the coil 33 wound around each of the teeth 31b of the stator core 34. The start line connection portion 54s is provided on one side of the circumferential direction of the edge portion on the outer side in the radial direction of each of the busbar terminals 51Ub, 51Ub, and 51Ub. Further, the end line connection portion 54e is provided on the other side of the circumferential direction of the edge portion on the outer side in the radial direction of each of the busbar terminals 51Ub, 51Ub, and 51Ub. The start line connection portion 54s and the end line connection portion 54e each include an engagement groove 28 and a cut and raised piece 29.

The engagement groove 28 is a groove extending from the end portion on the outer side in the radial direction of each of the busbar terminals 51Ub, 51Ub, and 51Ub toward the inner side in the radial direction, and the cut and raised piece 29 is cut and raised from the bottom portion of the engagement groove 28 toward the rear side. The start line portion 33s and the end line portion 33e of the coil 33 pulled out from the coil fitting grooves 43s and 43e of the insulator 32 described above are inserted into and engaged with the engagement groove 28. The start line portion 33s and the end line portion 33e inserted into the engagement groove 28 are pulled out to the rear side along the axial direction. In this state, the start line portion 33s and the end line portion 33e are fixed to the corresponding cut and raised piece 29 by welding. The start line portion 33s and the end line portion 33e of each coil 33 wound around the teeth 31b are thus connected to the start line connection portion 54s and the end line connection portion 54e of the corresponding busbar terminals 51Ub, 51Ub, and 51Ub.

Here, each of the busbar terminals 51Ub, 51Ub, and 51Ub radially protruding from the annular resin block 53 is provided, as viewed in the axial direction, at substantially the midpoint of the axial centers of the line winding portions (teeth 31b) of two coils 33 adjacent in the circumferential direction. That is, each of the busbar terminals 51Ub, 51Ub, and 51Ub is provided so as to straddle the line winding portions (teeth 31b) of two coils 33 adjacent in the circumferential direction when viewed in the axial direction. In each of the busbar terminals 51Ub, 51Ub, and 51Ub, the start line connection portion 54s, when viewed in the axial direction, is connected to the start line portion 33s of the coil 33 of the adjacent line winding portions on one side in the circumferential direction, and the end line connection portion 54e, when viewed in the axial direction, is connected to the end line portion 33e of the coil 33 of the adjacent line winding portions on the other side in the circumferential direction.

Further, as shown in FIG. 4, FIG. 6, and FIG. 7, the resin block 53 of the busbar unit 50 includes an annular-shaped block body portion 55 in which the substantially C-shaped busbar bodies 51Ua, 51Va, and 51Wa are embedded in the axial direction spaced apart from each other, and an inner flange portion 56 having a relatively thin wall thickness extending from an inner circumferential portion of the block body portion 55 to the inner side in the radial direction. The inner flange portion 56 is formed in an annular shape and protrudes to the inner side in the radial direction at a position closer to the front in the thickness direction (axial direction) of the block body portion 55. A stepped portion 57r is provided between the base portion (the end portion on the outer side in the radial direction) on the surface on the rear side of the inner flange portion 56 and the block body portion 55.

As shown in FIG. 6, twelve reinforcing ribs 58 are provided on the rear side surface of the inner flange portion 56 of the resin block 53 at equal intervals in the circumferential direction. Each of the reinforcing ribs 58 bulges toward the rear side from the rear side surface of the inner flange portion 56 by a predetermined thickness, and extends from the stepped portion 57r between the block body portion 55 and the inner flange portion 56 toward the inner side in the radial direction. As a result, the bending rigidity in the radial direction of the part of the inner flange portion 56 where the reinforcing rib 58 is configured is increased.

Each of the reinforcing ribs 58 is provided at a circumferential position corresponding to the midpoint between adjacent busbar terminals 51Ub, 51Vb, and 51Wb in the circumferential direction An adhesive filling port 59 that penetrates the resin block 53 in the up and down direction is formed at substantially the center of the extension direction (radial direction) of each of the reinforcing ribs 58. The adhesive filling port 59 is described in detail later.

As shown in FIG. 4 and FIG. 7, a projection strip portion 60 having an annular shape is provided on the front side surface of the block body portion 55 of the resin block 53. The projection strip portion 60 is provided along the inner circumferential edge portion of the block body portion 55. On the end surface of the front side of the projection strip portion 60, twelve locking projections 61 are provided at equal intervals in the circumferential direction. The end surface on the front side of the projection strip portion 60 is capable of abutting against the end surface on the rear side of the outer side flange portion 36o (see FIG. 4 and FIG. 5) of each of the insulators 32 of the stator 10.

Further, an engagement concave portion 44 (see FIG. 5) opening toward the rear side is formed between the outer side flange portions 36o of each of the insulators 32 adjacent to each other in the circumferential direction. The plurality of locking projections 61 protruding from the projection strip portion 60 of the resin block 53 may be fitted into the engagement concave portion 44 between the insulators 32. The resin block 53 (busbar unit 50) is positioned in the circumferential direction with respect to the stator core 34 by fitting a plurality of locking projections 61 into the engagement concave portions 44 between the insulators 32.

It is noted that with the plurality of locking projections 61 fitted into the engagement concave portions 44 between the insulators 32, the inner flange portion 56 and the reinforcing rib 58 of the resin block 53 bulge out to the inner side in the radial direction beyond the tip end portion of each of the teeth 31b of the stator 10.

As shown in FIG. 4 and FIG. 7, on the front side surface of the inner flange portion 56 of the resin block 53, twelve boss portions 62 having a prismatic shape are provided at equal intervals in the circumferential direction and protrude toward the front side. Each of the boss portions 62 is provided at a position overlapping in the axial direction with each of the reinforcing ribs 58 provided on the rear side surface of the inner flange portion 56. Each of the boss portions 62 is configured at a circumferential position corresponding to the midpoint between adjacent busbar terminals 51Ub, 51Vb, and 51Wb in the circumferential direction. Further, the tip end side of each of the boss portions 62 protrudes in the axial direction so as to face each of the protruding pieces 37 protruding from the rear side of the plurality of insulators 32. The tip end portion of each of the boss portions 62 is inserted into a concave portion 38 (see FIG. 4 and FIG. 5) formed in the protruding piece 37 of the insulator 32. The concave portion 38 of the protruding piece 37 is formed to have a capacity sufficiently larger than the tip end portion of the boss portion 62 into which it is inserted. The gap between the concave portion 38 and the boss portion 62 is a filling portion to be filled with an adhesive 63 (see FIG. 4). Each of the boss portions 62 inserted into the concave portion 38 of the protruding piece 37 is fixed to the corresponding protruding piece 37 by the adhesive 63 (see FIG. 4) filled in the concave portion 38.

The adhesive filling port 59 provided in the reinforcing rib 58 of the inner flange portion 56 is formed continuously in each of the boss portions 62 of the resin block 53. The adhesive filling port 59 is formed to reach the end surface of the front side of each of the boss portions 62. The adhesive filling port 59 is formed in a funnel shape such that the opening area gradually narrows from the end surface on the rear side of the reinforcing rib 58 toward the end surface on the front side of the boss portion 62. With the corresponding boss portion 62 on the resin block 53 side inserted into the concave portion 38 of the protruding piece 37 on the insulator 32 side, the adhesive 63 is filled from the rear side of the resin block 53 through the adhesive filling port 59. When the adhesive 63 filled in the concave portion 38 hardens in this manner, the resin block 53 of the busbar unit 50 is fixed to the end portion on the rear side of the insulator 32.

When the resin block 53 of the busbar unit 50 is fixed to the end portion on the rear side of the insulator 32 as described above, an inner flange portion 56, including a reinforcing rib 58 of the resin block 53, and a boss portion 62 bulge out to the inner side in the radial direction beyond the teeth 31b of the stator core 34. When the stator 10 and the rotor 11 are assembled into the housing 13 together with the sensor unit 45 and the like, the inner flange portion 56 and the boss portion 62 protrude a predetermined amount to the inner side in the radial direction beyond the outer circumferential surface of the rotor 11 between the rotor 11 and the sensor unit 45.

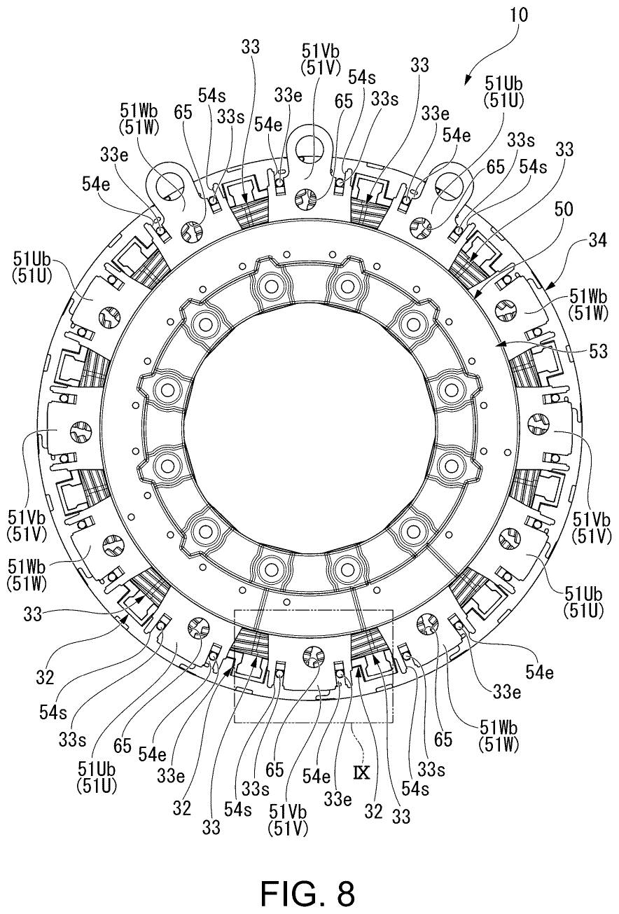

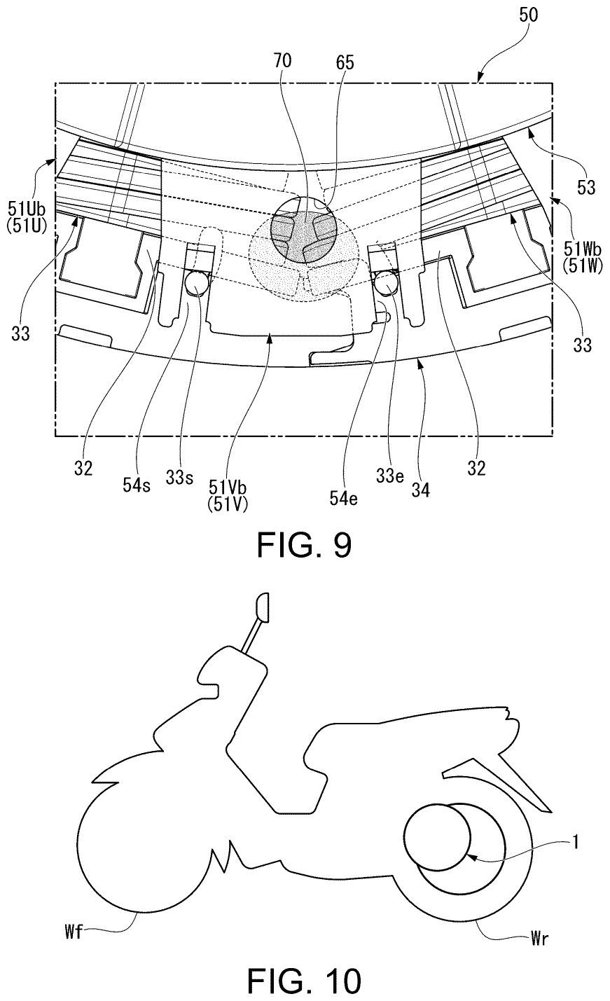

FIG. 8 is a plan view of the stator 10 viewed from the rear side, and FIG. 9 is an enlarged view of part IX in FIG. 8.

A filling opening 65 having a circular shape is formed substantially at the center position of the circumferential direction of each of the busbar terminals 51Ub, 51Ub, and 51Ub (between the start line connection portion 54s and the end line connection portion 54e). The filling opening 65 penetrates each of the busbar terminals 51Ub, 51Ub, and 51Ub in the thickness direction. The filling opening 65 of each of the busbar terminals 51Ub, 51Ub, and 51Ub opens in an approximately intermediate region between each of two adjacent coils 33 in the circumferential direction when viewed in the axial direction. More specifically, the filling opening 65 opens so as to face the outer surfaces of the outermost layers of the winding portions of the two coils 33 and to face the vicinity of the base portion of the end line portion 33e of one of the coils 33.

To be precise, the position where the filling opening 65 is formed in each of the busbar terminals 51Ub, 51Ub, and 51Ub is not exactly in the center of the circumferential direction of each terminal, but is biased toward the end line connection portion 54e side with respect to the center position. That is, the filling opening 65 is configured at a position closer to the end line connection portion 54e than to the start line connection portion 54s in each of the busbar terminals 51Ub, 51Ub, and 51Ub.

In this embodiment, the filling opening 65 is formed shifted by 1° in center angle centered on the axial center o with respect to the center position of the circumferential direction of each of the busbar terminals 51Ub, 51Ub, and 51Ub toward the end line connection portion 54e side. Further, the diameter of the filling opening 65 is set to approximately 5 mm from the viewpoints of maintaining the strength of each of the busbar terminals 51Ub, 51Ub, and 51Ub and suppressing the current density (suppressing heat generation due to an increase in current density).

The filling opening 65 is used as a filling port for adhesive 70 (FIG. 9) when adhesively fixing the base portion of the end line portion 33e to the line winding portion of the coil 33 as a preliminary process for connecting the end line portion 33e of each coil 33 to the end line connection portion 54e of the busbar terminals 51Ub, 51Ub, and 51Ub.

Actually, when the base portion of the end line portion 33e is adhesively fixed to the line winding portion of the coil 33, the tip end portion of a nozzle of a filling device (not shown) is inserted into the filling opening 65 from the outer side in the axial direction of the busbar terminals 51Ub, 51Ub, and 51Ub, and the adhesive 70 discharged from the nozzle is filled into the winding portion of the coil 33 on the base portion side of the end line portion 33e. At this time, the tip end portion of the nozzle may be brought sufficiently close to the winding portion on the base portion side of the end line portion 33e through the filling opening 65. Thus, as shown in FIG. 9, a necessary and sufficient amount of adhesive 70 may be filled in the winding portion on the base portion side of the end line portion 33e. In this manner, when the filled adhesive 70 hardens, the end line portion 33e is fixed to the winding portion of the coil 33, and separation (loosening) of the end line portion 33e from the winding portion does not occur.

### <Operation of Electric Motor 1>

A three-phase drive current is supplied to the plurality of coils 33 of the stator 10 through a drive circuit of the controller. When a drive current is supplied to the coil 33 in this manner, a rotating magnetic field is generated in the stator 10. As a result, the rotor 11 receives a torque from the rotating magnetic field and rotates in a predetermined direction.

At this time, the rotation of the rotor 11 is detected by the sensor unit 45 provided opposite to the rear side of the rotary shaft 12. The rotation information of the rotary shaft 12 detected by the sensor unit 45 is output to a controller, and the controller controls the drive current based on the rotation information.

### Effect of Embodiment

As described above, in the electric motor 1 of this embodiment, a filling opening 65 is provided between the start line connection portion 54s and the end line connection portion 54e of each of the busbar terminals 51Ub, 51Ub, and 51Ub of the busbar unit 50. Due to this, when adhering the vicinity of the end line portion 33e of the coil 33 to the winding portion, the adhesive 70 may be directly filled in the vicinity of the end line portion 33e of the coil 33 through the filling openings 65 of the busbar terminals 51Ub, 51Ub, and 51Ub.

Thus, when the electric motor 1 of this embodiment is adopted, the adhesive 70 is less likely to flow into unnecessary portions other than those near the end line portion 33e, and as a result, the amount of adhesive 70 to be filled may be reduced. Further, since the amount of adhesive 70 filled may be reduced in this manner, the curing time of the adhesive 70 may be shortened, and the assembly time of the electric motor 1 may be shortened.

In this way, by adopting the electric motor 1 of this embodiment, the amount of adhesive 70 used may be reduced and to the efficiency of the assembly work may be improved. Thus, it may contribute to Goal 7 of the United Nations' Sustainable Development Goals (SDGs), which is to “Ensure access to affordable, reliable, sustainable and modern energy for all.”

Further, in the electric motor 1 of this embodiment, the filling opening 65 of each of the busbar terminals 51Ub, 51Ub, and 51Ub is configured at a position closer to the base portion of the end line portion 33e of the other adjacent coil 33 than to the base portion of the start line portion 33s of one adjacent coil 33. Due to this, when the electric motor 1 of this embodiment is adopted, the vicinity of the end line portion 33e may be easily and accurately filled into the winding portion of the other coil 33 through the filling opening 65 of each of the busbar terminals 51Ub, 51Ub, and 51Ub.

In particular, in the electric motor 1 of this embodiment, the filling opening 65 is formed at a position closer to the end line connection portion 54e than to the start line connection portion 54s of each of the busbar terminals 51Ub, 51Ub, and 51Ub. Due to this, while each of the busbar terminals 51Ub, 51Ub, and 51Ub is configured at the intermediate position between the line winding portions of two adjacent coils 33 in the circumferential direction, only the filling opening 65 may be shifted toward the base portion side of the start line portion 33s of the one coil 33. Thus, when this configuration is adopted, the busbar terminals 51Ub, 51Ub, and 51Ub may be configured more easily.

However, the filling opening 65 may be formed in the intermediate position between the start line connection portion 54s and the end line connection portion 54e of the busbar terminals 51Ub, 51Ub, and 51Ub, and all of the busbar terminals 51Ub, 51Ub, and 51Ub may be shifted toward the end line portion 33e so that the filling opening 65 is close to the vicinity of the end line portion 33e of the other coil 33.

Furthermore, the electric motor 1 of this embodiment has a plurality of busbar terminals 51Ub, 51Ub, and 51Ub having filling openings 65 integrated into the annular-shaped busbar unit 50. That is, the busbar unit 50 includes the busbars 51U, 51V, and 51W, and an insulating resin block 53 that holds the busbars 51U, 51V, and 51W in a mutually separated state, and each of the busbars 51U, 51V, and 51W includes a substantially C-shaped busbar body 51Ua, 51Va, and 51Wa, embedded in resin block 53, and busbar terminals 51Ub, 51Ub, and 51Ub, protruding toward the outer side in the radial direction from the busbar bodies 51Ua, 51Va, and 51Wa. Due to this, by positioning and fixing the busbar unit 50 to one end side in the axial direction of the stator core 34 (insulator 32), the filling openings 65 of all busbar terminals 51Ub, 51Ub, and 51Ub may be positioned at positions where the adhesive 70 may be easily filled. Thus, when the electric motor 1 of this embodiment is adopted, the manufacture of the electric motor 1 may be facilitated.

It should be noted that the present invention is not limited to the above-mentioned embodiment, and various design changes are possible within the scope of the present invention. For example, in the above-mentioned embodiment, the stator 10 is formed by twelve split cores 30, but the number of split cores 30 constituting the stator 10 may be other than twelve.

In the above-mentioned embodiment, each of the three busbars 51U, 51V, and 51W for the U-phase, V-phase, and W-phase is partially embedded inside a common resin block 53. However, the busbars 51U, 51V, and 51W do not have to be integrated with the resin block 53. For example, the busbars 51U, 51V, and 51W may be secured to respective insulating holding members.

### REFERENCE SIGNS LIST

1 . . . Electric motor, 2 . . . Chain, 10 . . . Stator, 11 . . . Rotor, 12 . . . Rotary shaft, 12e . . . End surface, 12o . . . Rotation output portion, 13 . . . Housing, 14 . . . Case body, 15 . . . Rear cover, 16 . . . Front cover, 20 . . . Rotor body, 21 . . . Permanent magnet, 22F, 22R . . . Bearing, 23 . . . Recessed shape portion, 24 . . . Sensor magnet, 25 . . . Rotation sensor, 26 . . . Through hole, 27 . . . Support portion, 28 . . . Engagement groove, 29 . . . Cut and raised piece, 30 . . . Split core, 31 . . . Core portion, 31a . . . Core back split piece, 31b . . . Teeth, 32 . . . Insulator, 32b . . . Split block, 33 . . . Coil, 33e . . . End line portion, 33s . . . Start line portion, 34 . . . Stator core, 35 . . . Encircling portion, 36i . . . Inner side flange portion, 36o . . . Outer side flange portion, 37 . . . Protruding piece, 38 . . . Concave portion, 40 . . . Thermistor housing portion, 41 . . . Thermistor, 42 . . . Plate spring, 43s, 43e . . . Coil fitting groove, 44 . . . Engagement concave portion, 45 . . . Sensor unit, 46 . . . Sensor substrate, 47 . . . Sensor connector, 48 . . . Sensor harness, 49 . . . Cover member, 50 . . . Busbar unit, 51U, 51V, 51W . . . Busbar, 51Ua, 51Va, 51Wa . . . Busbar body, 51Ub, 51Vb, 51Wb . . . Busbar terminal, 51Ub1, 51Vb1, 51Wb1 . . . Terminal base portion, 51Ub2, 51Vb2, 51Wb2 . . . Terminal connection portion, 52 . . . Drive connector, 53 . . . Resin block, 54s . . . Start line connection portion, 54e . . . End line connection portion, 55 . . . Block body portion, 56 . . . Inner flange portion, 57r . . . Stepped portion, 58 . . . Reinforcing rib, 59 . . . Adhesive filling port, 60 . . . Projection strip portion, 61 . . . Locking projection, 62 . . . Boss portion, 63 . . . Adhesive, 65 . . . Filling opening, 70 . . . Adhesive, TU, TV, TW . . . Power terminal, A . . . Axial direction, R . . . Radial direction, C . . . Circumferential direction, FR . . . Front side, o . . . Axial center, Wf . . . Front wheel, Wr . . . Rear wheel.

What is claimed is:

1. An electric motor, comprising:
a stator, having an annular shape;
a rotor, provided on an inner side in a radial direction of the stator and rotating relative to the stator,
wherein the stator comprises:
a stator core, having a plurality of teeth protruding from a plurality of points in a circumferential direction to an inner side in a radial direction;
a plurality of coils, wound around each of the teeth; and
a busbar unit, provided on one end side in an axial direction of the stator core and supplying electric power to each of the coils wound around the teeth,
the busbar unit has a plurality of busbar terminals configured to straddle winding portions of adjacent coils in a circumferential direction when viewed in the axial direction,
two positions spaced apart in a circumferential direction of each of the busbar terminals are provided with a start line connection portion to which a start line portion of one adjacent coil is connected and an end line connection portion to which an end line portion of other adjacent coil in a circumferential direction is connected, respectively, and
a filling opening for filling an adhesive into a winding portion of the coil in a vicinity of the end line portion is provided between the start line connection portion and the end line connection portion of each of the busbar terminals.

2. The electric motor according to claim 1, wherein the filling opening is provided at a position closer to a base portion of the end line portion of other adjacent coil than to a base portion of the start line portion of one adjacent coil.

3. The electric motor according to claim 2, wherein the filling opening is formed at a position closer to the end line connection portion than to the start line connection portion of the busbar terminal.

4. The electric motor according to claim 1, wherein the busbar unit comprises:
three busbars for U-phase, V-phase, and W-phase; and
an insulating resin block, holding the three busbars in a mutually separated state, and
each of the busbars comprises:
a busbar body, having a substantially C-shape and embedded in the resin block; and
a busbar terminal, protruding from the busbar body to an outer side in a radial direction.
